(19) United States
(12) Patent Application Publication
(10) Pub. No.: US 2009/0083391 A1
(43) Pub. Date: Mar. 26, 2009

(54) AUTOMATIC CONTROL SYSTEM WITH NETWORK GATEWAY AND METHOD FOR OPERATING THE SAME

(76) Inventor: Jen-Hsueh OH YANG, Taoyuan Shien (TW)

Correspondence Address: HDLS Patent & Trademark Services, P.O. BOX 220746, CHANTILLY, VA, 20153-0746, US

(21) Appl. No.: 11/858,407

(22) Filed: Sep. 20, 2007

(51) Int. Cl. G06F 15/16

(52) U.S. Cl. 709/211

(57) ABSTRACT

An automatic control system includes a host, a network gateway operatively connected to the host, and a plurality of programmable logic controllers (PLC) operatively connected to the network gateway. The network gateway includes a controller and registers. The controller backups data from specific addresses in the PLC to the registers sequentially for each predetermined time period. When the controller receives an accessing command from the host and the accessing command designates the specific addresses, the controller sends the data, which is corresponding to the designated address and already stored in the registers, to the host. The accessing efficiency can be enhanced because part of data in the PLC is cached in the network gateway.

### BACKGROUND OF THE INVENTION

1. Field of the Invention

The present invention relates to an automatic control system, especially to an automatic control system with network gateway and method for operating the same.

2. Description of Prior Art

The conventional electrical control system generally uses relay as control switch. However, the system need re-manufacture when the design is changed. Moreover, the relay-based control system has the problems of poor contact, abrasion, and bulky size. Therefore, the relay-based control system has high cost, low reliability and maintenance difficulty. To overcome above drawbacks, DEC proposed the concept of Programmable logic controller (PLC) in 1969 to replace the logic function, timing function and counting function in relay control. Moreover, PLC has the additional advantages of versatile control, expansion ability and easy maintenance.

The basic internal components of PLC include CPU module, input module and output module. The CPU of PLC reads input signals from the input module, fetches control commands from memory thereof and performs the control commands by ALU therein. Afterward, the PLC outputs control signals through the output module to external devices to control the external devices.

As the fast development of network technology and computer hardwire, in current automatic control system, a host computer can operate or access data in a PLC through a broad-band network such as a broad-band Internet.

FIG. 1 shows the schematic view of a related art automatic control system, wherein user operates a host computer 10a to access data in a PLC 30a through a network gateway 20a. The host computer 10a can reach the network gateway 20a through high speed network such as ADSL or T1 network. The network gateway 20a accesses the PLC 30a through low speed interface such as RS-232C, RS-422, or RS-485). In other word, the PLC is generally connected to the network gateway 20a through legacy low speed serial network. Therefore, network congestion is liable to occur when the host computer 10a wants to access lots of PLCs. In a related art system, Anybus provides a memory region in the network gateway 20a, which has data exchange with devices in sub-network, namely, the PLCs. However, the host computer needs to know the mapping relationship between the address in the network gateway and the address of data in the PLC 30a. It is complicated for the user of the host computer 10a to know the setting.

US patent publication 2006/0041630 discloses a network gateway between an Ethernet and low speed serial network. The network gateway is used to scan the input and output status of the PLCs at remote sides and cannot enhance data accessing efficiency.

### SUMMARY OF THE INVENTION

It is an object of the present invention to provide an automatic control system with network gateway to enhance data accessing efficiency and method for operating the same.

Accordingly, the present invention provides an automatic control system, which includes a host, a network gateway operatively connected to the host, and a plurality of programmable logic controllers (PLC) operatively connected to the network gateway. The network gateway includes a controller and registers. The controller backup data from specific addresses in the PLC to the registers sequentially for each predetermined time period. When the controller receives an accessing command from the host and the accessing command designates the specific addresses, the controller sends the data, which is corresponding to the designated address and already stored in the registers, to the host. The accessing efficiency can be enhanced because part of data in the PLC is cached in the network gateway.

### BRIEF DESCRIPTION OF DRAWING

The features of the invention believed to be novel are set forth with particularity in the appended claims. The invention itself however may be best understood by reference to the following detailed description of the invention, which describes certain exemplary embodiments of the invention, taken in conjunction with the accompanying drawings in which:

FIG. 1 shows the schematic view of a related art automatic control system.

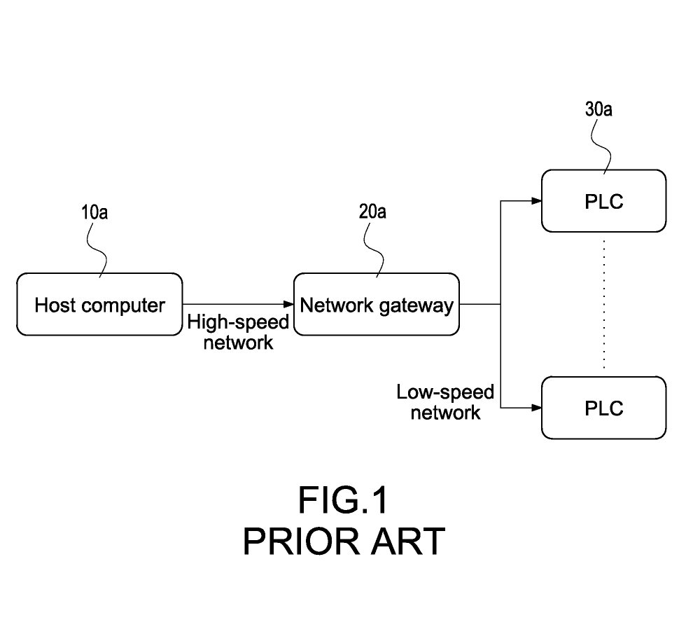

FIG. 2 shows a schematic view of the automatic control system according to a preferred embodiment of the present invention.

FIG. 3A shows the flowchart of data refreshing operation performed by the controller.

FIG. 3B shows the flowchart of data accessing operation performed by the controller.

FIGS. 4A and 4B show the arrangement of registers in the network gateway.

FIG. 5 demonstrates the operation flow of the method of the present invention for operating a network gateway in an automatic control system.

### DETAILED DESCRIPTION OF THE INVENTION

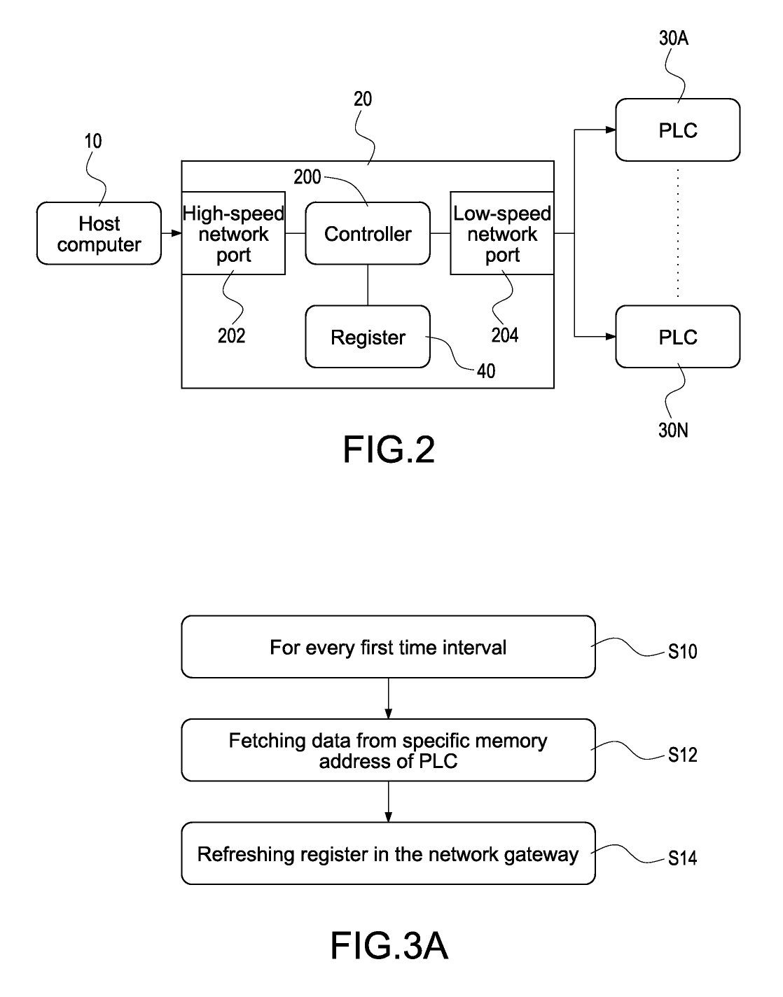

FIG. 2 shows a schematic view of the automatic control system according to a preferred embodiment of the present invention. The automatic control system comprises a host computer 10, a network gateway 20 and a plurality of PLCs 30A-30N. The host computer 10 is operatively connected to the network gateway 20 through a high speed network such as ADSL or T1 network. The network gateway 20 is operatively connected to the plurality of PLCs 30A-30N through low speed serial interfaces such as RS-232C, RS-422, or RS-485. The network gateway 20 comprises a controller 200, a high-speed network port 202, a low-speed network port 204 and a set of registers 40 (only one is shown), wherein the high-speed network port 202, the low-speed network port 204 and the registers 40 are electrically connected to the controller 200. The PLCs 30A-30N can control peripheral elements such as sensor and store sensed parameters in specific memory thereof. The host computer 10 fetches the sensed parameters of the PLCs 30A-30N through the network gateway 20. The host computer 10 generally has better processing ability and can perform process on the fetched sensed parameters.

The controller 200 is adapted to perform a data refreshing and accessing process. In the data refreshing process, the controller 200 sequentially updates data in specific memory of the PLCs 30A-30N to specific addresses in the registers 40 for every first predetermined time interval (for example, 30 ms). In the data accessing process, the controller 200 further checks whether the host computer 10 has issued accessing command for every second predetermined time interval (for example, 1 ms).

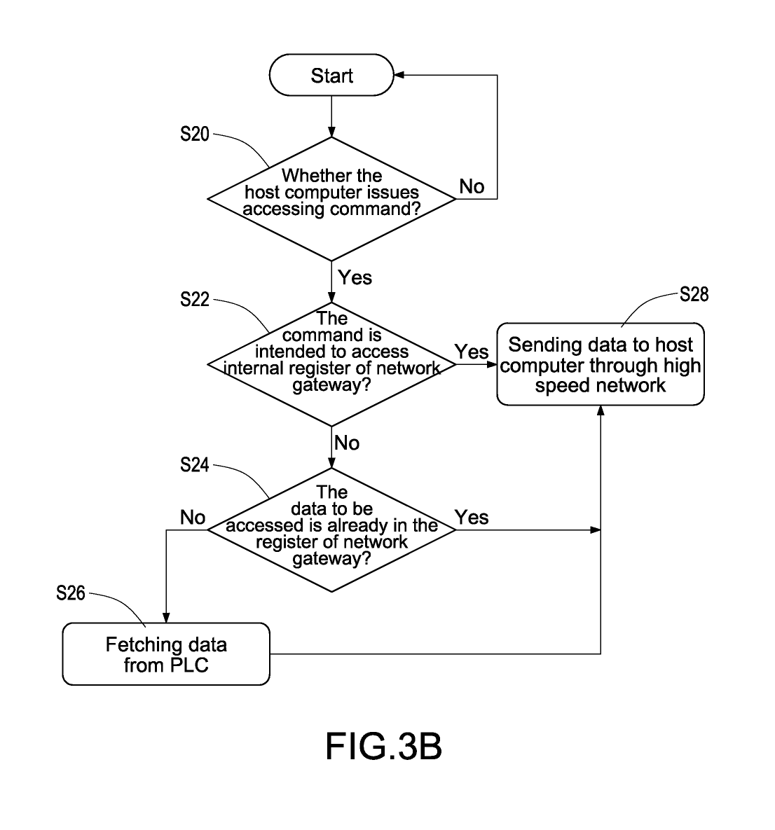

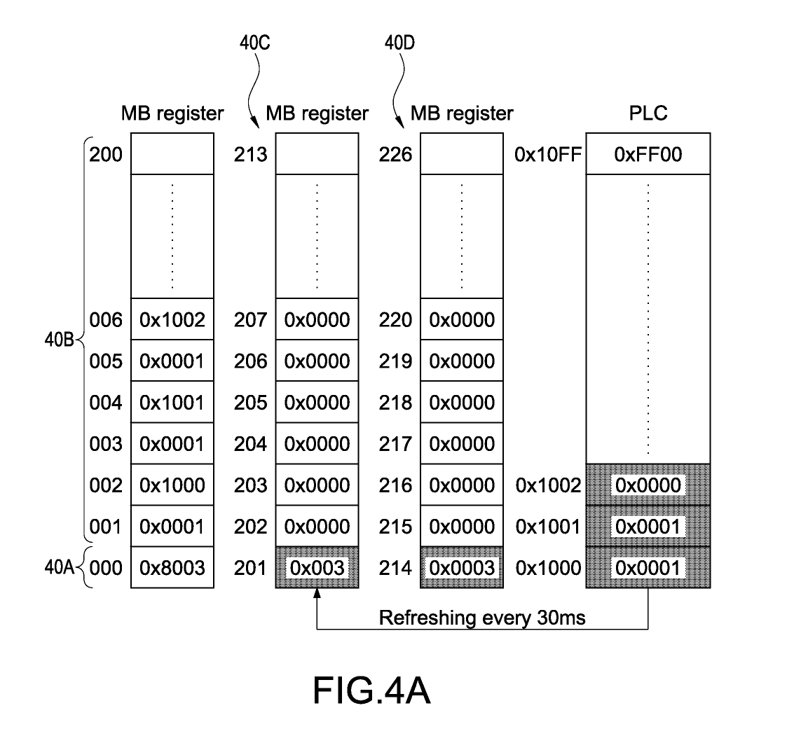

FIG. 3A shows the flowchart of data refreshing operation performed by the controller 200.

FIG. 3B shows the flowchart of data accessing operation performed by the controller 200. As shown in FIG. 3A, the controller 200 performs the data refreshing operation for every first predetermined time interval (for example, 30 ms) in step S10, and the controller 200 fetches data from specific memory in the PLCs 30A-30N in step S12. Afterward, the controller 200 updates the registers 40 thereof corresponding to the fetched data in step S14. As shown in FIG. 3B, the controller 200 performs the data accessing operation and checks whether the host computer 10 has issued an accessing command for every second predetermined time interval (for example, 1 ms) in step S20. If the controller 200 detects that the host computer 10 has issued an accessing command in step S20, then the controller 200 checks whether the accessing commands is for accessing internal register within the network gateway 20 in step S22. If the accessing commands is for accessing internal register within the network gateway 20 in step S22, then data associated with the accessing command is sent to the host trough the high speed network in step S28. If the accessing commands is not for accessing internal register within the network gateway 20 in step S22, then the controller 200 checks whether the data to be accessed is already stored in the register 40 in step S24. If true, then the data associated with the accessing command is sent to the host trough the high speed network in step S28. If false, then the controller 200 fetches the data corresponding to the accessing command and intended to access the PLC from one of the PLC 30A-30N in step S26. Afterward, the fetched data is sent to the host trough the high speed network in step S28.

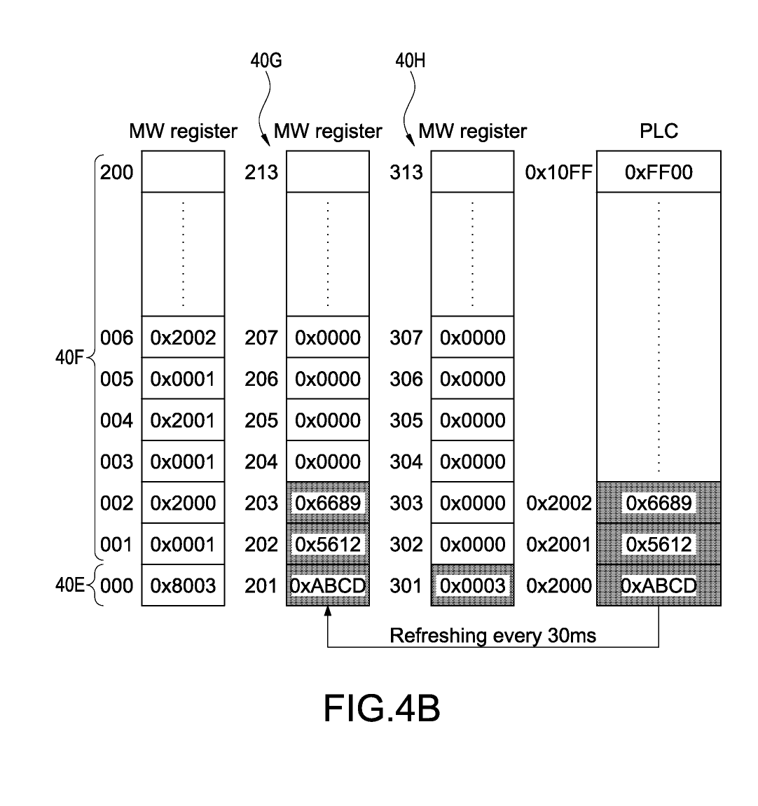

FIGS. 4A and 4B show the arrangement of registers 40 in the network gateway 20. According to the present invention, the register 40 can be classified as bit register MB and word register MW, which monitor the data of bit element and word element, respectively.

As shown in FIG. 4A, the bit registers MB mainly comprises four sections: the first monitoring number storage 40A (including register MB0), the first station number storage 40B (including registers MB1-MB200), the first monitoring value storage 40C (including registers MB201-MB213), and the first monitoring status storage 40D (including registers MB214-MB226).

The first monitoring number storage 40A is used to record the number of PLC under monitoring (refreshing) and the option for enabling cache function. When bit 15 in the register MB0 of the first monitoring number storage 40A is logical one, the cache mode is enabled. When cache mode is enabled, the controller 200 checks whether the data corresponding to the accessing command is already present in the bit register MB, namely, the step S24 is performed. When bit 15 in the register MB0 of the first monitoring number storage 40A is logical zero, the cache mode is disabled. When cache mode is disabled, the controller 200 does not check whether the data corresponding to the accessing command is already present in the bit register MB, namely, the step S24 is not performed. Moreover, when the number of monitored PLC stored in the first monitoring number storage 40A exceeds a predetermined range, the cache mode is automatically disabled. For example, if the number of monitored PLC is set to be 1 to 16 units, then the cache mode is automatically disabled when the actual number of monitored PLCs is less than one or larger than sixteen.

The first station number storage 40B is used to store the station number of a PLC under monitoring; and the memory address for a monitored device associated with the PLC with specific station number. For example, the registers of odd number in the first station number storage 40B can be used to record the station number of a PLC. The registers of even number in the first station number storage 40B can be used to record the memory address in a PLC with specific station number, wherein the memory address is used to store information from a sensor device controlled by the PLC.

The first monitor value storage 40C is used to store the data (sensed parameter) of a sensor device controlled by a PLC. The first monitor status storage 40D is used to store the monitoring status such as whether refreshing operation is successful.

As shown in FIG. 4B, the word register MW mainly comprises four sections: the second monitoring number storage 40E (including register MW0), the second station number storage 40F (including registers MW1-MW200), the second monitoring value storage 40G (including registers MW201-MW213), and the second monitoring status storage 40H (including registers MW214-MW226).

The second monitoring number storage 40E is used to record the number of PLC under monitoring and the option for enabling cache function. When bit 15 in the register MW0 of the second monitoring number storage 40E is logical one, the cache mode is enabled. When cache mode is enabled, the controller 200 checks whether the data corresponding to the accessing command is already present in the word register MW, namely, the step S24 is performed. When bit 15 in the register MW0 of the first monitoring number storage 40E is logical zero, the cache mode is disabled. When cache mode is disabled, the controller 200 does not check whether the data corresponding to the accessing command is already present in the word register MW, namely, the step S24 is not performed. Moreover, when the number of monitored PLC stored in the second monitoring number storage 40E exceeds a predetermined range, the cache mode is automatically disabled. For example, if the number of monitored PLC is set to be 1 to 16 units, then the cache mode is automatically disabled when the actual number of monitored PLCs is less than one or larger than sixteen.

The second station number storage 40F is used to store the station number of a PLC under monitoring; and the memory address for a monitored device associated with the PLC with specific station number. For example, the registers of odd number in the second station number storage 40F can be used to record the station number of a PLC. The registers of even number in the second station number storage 40F can be used to record the memory address in a PLC with specific station number, wherein the memory address is used to store information from a sensor device controlled by the PLC.

The second monitor value storage 40G is used to store the data (sensed parameter) of a sensor device controlled by a PLC. The second monitor status storage 40H is used to store the monitoring status such as whether refreshing operation is successful.

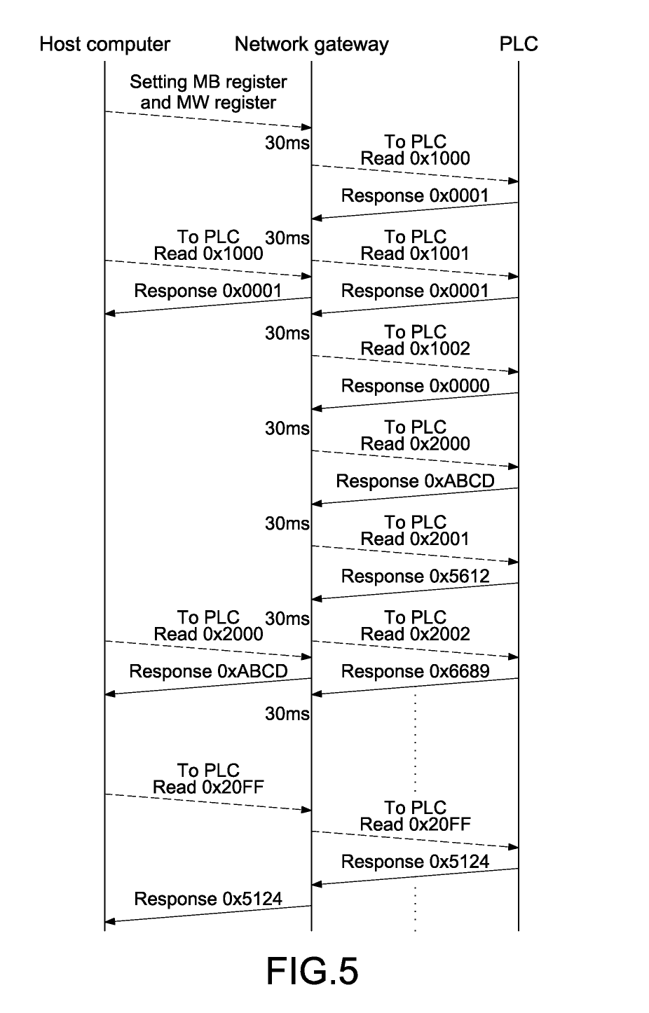

FIG. 5 demonstrates the operation flow of the method of the present invention for operating a network gateway in an automatic control system. With reference to FIG. 4A and the right portion of FIG. 5, the network gateway 20 sequentially updates the content in the bit registers MB according to the station number and the device address stored in the first station number storage 40B. As shown in FIG. 5, each of the registers MB001, MB003, and MB005 has the stored value of 0x0001, which indicates the station number 0x0001 and is associated with PLC 30A. The contents of the registers MB002, MB004, and MB006 are 0x1000, 0x1001 and 0x1002, respectively. It means that the addresses 0x1000, 0x1001 and 0x1002 in the PLC 30A need refreshing operation to store in corresponding portion in the bit registers MB (namely updating the contents in the bit registers MB).

With reference to the left portion of FIG. 5, the commands issued from the host computer 10 is processed individually. The first command is intended to access the address 0x000 in the PLC 30A under monitoring (with station number 0001). The address 0x000 in the PLC 30A is subjected to refreshing operation by the network gateway 20, and the data in the address 0x1000 in the PLC 30A is already refreshed in previously fetching operation (see the top right part of FIG. 5). Therefore, as shown in FIG. 4A, the new data 0x0001 is stored in corresponding register MB201.

With reference again to the left portion of FIG. 5, the third accessing command issued from the host computer 10 is intended to access the address 0x20FF of the PLC 30A (with station number 0001). The address 0x20FF of the PLC 30A is not under refreshing operation according to the record in the bit registers MB. Therefore, the network gateway 20 firstly reads the data in the address 0x20FF of the PLC 30A, namely, the data 0x5124, through low speed interface, and then sends the data 0x5124 to the host computer 10 through high speed network.

As shown in FIG. 5, the network gateway 20 sequentially updates the registers thereof by reading data from specific addresses of specific PLCs, where the information of the specific addresses and the specific PLCs is recorded in the registers MB (corresponding to bit element) or registers MW (corresponding to word element). When the host computer 10 is intended to access the PLC, the network gateway 20 checks whether the data is already stored therein. When the desired data is already present in the registers of the network gateway 20, the network gateway 20 sends the data to the host computer 10 through high speed network and the data fetching operation from low speed interface can be eliminated. Therefore, the network monitoring efficiency can be enhanced.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

What is claimed is:

1. An automatic control system with network gateway function, comprising:
a host computer;
a network gateway operatively connected to the host computer through a high-speed network; and
a plurality of programmable logic controllers (PLC), each operatively connected to the network gateway through a low-speed interface,
wherein the network gateway comprises a controller and a plurality of registers, the controller is adapted to update the registers by sequentially fetching data from specific address in the PLC for every predetermined time interval,
wherein the controller is adapted to send refreshed data already stored in the registers when the controller receives an accessing command from the host computer and the accessing command is intended to access the refreshed data.

2. The automatic control system in claim 1, wherein the registers are bit registers or word registers.

3. The automatic control system in claim 2, wherein the registers further comprise a monitoring number storage to record the number of PLC under monitoring.

4. The automatic control system in claim 2, wherein the registers further comprise a station number storage to store a station number of a PLC under monitoring.

5. The automatic control system in claim 2, wherein the registers further comprise a station number storage to store memory address to be monitored in the PLC.

6. The automatic control system in claim 2, wherein the registers further comprise a monitoring status storage to record a monitoring status of the PLC.

7. The automatic control system in claim 1, wherein the high-speed network is ADSL network or T1 network.

8. The automatic control system in claim 1, wherein the low-speed interface is RS-232C, RS-422, or RS-485.

9. A method for providing network gateway function in an automatic control system, the automatic control system comprising a host computer, a network gateway operatively connected to the host computer, and a plurality of programmable logic controllers (PLC) operatively connected to the network gateway, the method comprising:
sequentially backing up data in specific memory of the PLC to the network gateway for every predetermined first time interval;
the network gateway receiving an accessing command from the host computer; and
the network gateway sending backed up data therein to the host computer if the data is to be accessed by the accessing command and already stored in the network gateway.

10. The method in claim 9, wherein the network gateway checks whether the host computer issues accessing command for every predetermined second time interval, wherein the second time interval is smaller than the first time interval.

11. The method in claim 9, further comprising:
providing registers in the network gateway for storing the backed up data.

12. The method in claim 11, further comprising:
storing a number of PLC to be monitored in the registers.

13. The method in claim 11, further comprising:
storing a number of PLC to be monitored in the registers.

14. The method in claim 11, further comprising:
storing a monitoring status for each of the PLC to be monitored in the registers.
